(19) United States
(12) Patent Application Publication
(10) Pub. No.: US 2011/0114129 A1
(43) Pub. Date: May 19, 2011

(54) METHODS AND APPARATUSES FOR CONTROLLING CONTAMINATION OF SUBSTRATES

(75) Inventors: Oleg P. Kishkovich, Grenville, RI (US); David L. Halbmaier, Shorewood, MN (US); Anatoly Grayfer, Newton, MA (US)

(73) Assignee: ENTEGRIS, INC., Billerica, MA (US)

(21) Appl. No.: 12/809,049

(22) PCT Filed: Dec. 18, 2008
(86) PCT No.: PCT/US08/87474

§ 371 Date: Jan. 21, 2011

(30) Foreign Application Priority Data
Dec. 18, 2007 (US) 61014709

(51) Int. Cl. B08B 9/00; A47L 9/00; B65D 85/00

(52) U.S. Cl. 134/22.1; 15/300.1; 206/710

(57) ABSTRACT

Components, systems, and methods for maintaining an extremely dry environment within substrate containers formed of polymers provides supplemental exterior gas washing of the substrate container to minimize permeation of moisture and oxygen through the polymer walls of the container and to control desorption of water entrapped in the polymer walls of the container.

### RELATED APPLICATION

The present application claims the benefit of U.S. Provisional Application No. 61/014,709 filed Dec. 18, 2007, which is incorporated herein in its entirety by reference.

### Field of the Invention

This invention relates to substrate containers and maintaining dryness and minimizing contamination within the interior of such containers.

### BACKGROUND OF THE INVENTION

It has been realized that moisture within the polymer walls of reticle pod or wafer containers, as well as moisture permeating through the polymer walls, is a source of contamination of substrates contained in such containers.

During transportation, storage, or pauses in subsequent manufacturing processes, semiconductor wafers which are stored in special containers, such as SMIF pods (acronym for standardized mechanical interface), and FOUPs (acronym for front opening unified pod). Depending on a number of factors such as size of production run and cycle time, wafers may sit in such containers for a substantial time between processing steps. During this time processed wafers are affected by ambient moisture, oxygen and other AMC's (“airborne molecular contaminants”) detrimental to production yield.

For instance, moisture can cause uncontrolled native oxide growth, formation of haze and corrosion, whereas oxygen is known to affect Cu-interconnect reliability. Experimental data and computational studies have shown that closed FOUPs, with wafers inside can be effectively purged with a continuous flow of nitrogen through an inlet port on the lower base of the shell or the FOUP's door. It is known that a gentle flow of nitrogen at about 4 liters per minute provides for significant reduction of the oxygen and moisture level inside a loaded FOUP, down to−1% RH and 1% of 0₂ in just in 4 to 5 minutes. Experimental data shows also that termination of the nitrogen purge flow can cause very rapid, within minutes, increase of moisture concentration, levels greater than 1% inside the FOUP. This effect is believed to be caused by moisture permeation through the walls of the FOUP and by moisture desorption from the polycarbonate walls of the FOUP.

A better system and process is needed to better protect substrates, for example wafers, against ambient moisture and oxygen.

### SUMMARY OF THE INVENTION

In certain embodiments, a double purge of loaded substrate containers, for example FOUPs, during their storage and intrabay transportation such as with the aid of PGV (personal guided vehicle) is provided. The double purge may includes a flow of clean dry air (“CDA”), or other purge gas directed or confined to the outside of the substrate container which prevents or minimizes permeation of moisture into the substrate container and effects progressive drying of the polymer confinement walls which may be, for example, polycarbonate. Conventional interior purging, such as by nitrogen, of the interior of the FOUP will prevent oxygen build-up and provides drying of the confinement walls from the interior.

Partition walls or shrouds inside the storage stockers for the substrate containers will ensure effective circulation of CDA. Similar shrouds and partition walls inside intra bay mini-storages and enclosures on purge stations will provide effective CDA usage also. PGVs equipped with re-chargeable low-pressure vessels filled with CDA and N2 may provide double purging for FOUPs in transit.

In embodiments of the invention, a system for maintaining an extremely dry environment within substrate containers formed of polymers provides supplemental exterior gas washing of the substrate container exterior to minimize permeation of moisture and oxygen through the polymer walls of the container and to further provide for desorption of water entrapped in the polymer walls of the container.

Specific shrouds and/or purge gas directing plates can be provided downstream from discharge nozzles as part of stockers to control and contain the exterior purge. Shrouds and double walls may be provided to wafer container to provide a confined pathway for the exterior purge gas wash.

A feature and advantage of the invention in certain embodiments provides a substrate container with a wall cavity to provide an inner wall with exterior purge capabilities for an outwardly facing surface of said inner wall. Said wall cavity may be substantially closed with a restricted inlet area, for example, less than 1 square inch. Also the outlet area may be restricted, for example, less than one square inch. The inlet and outlet may have a further restriction member in the inlet and/or outlet, for example a check valve or filter. A feature and advantage of the invention in certain embodiments provides a stocker with substrate container shroud not fixed to the wafer container providing a gap of about 0.25 inch to about two inches from the exterior surface of the wafer container.

A feature and advantage of the invention in certain embodiments provides a substrate container that has in interior containment wall with an exterior shroud fixedly attached to the wafer container providing a gap of about 0.25 inch to about two inches from the exterior surface and creating a cavity between the fixedly attached shroud and the of the interior containment wall whereby a exterior purging gas can be provided to the cavity.

In an embodiment, the gap is less than 2 inches for the majority of the inside surface of the shroud.

A feature and advantage of certain embodiments of the invention is a method of modifying substrate containers by adding exterior shroud pieces to the substrate container to provide a cavity between an exteriorly facing surface of a containment wall of the substrate container and the shroud wherein an exterior purging gas may be provided thereto.

A feature and advantage of certain embodiments of the invention provides a purging outlet from a substrate container wherein purging gas that is circulated within the interior of the substrate container is redirected after the purging gas leaves the interior to wash the exterior surface of the substrate container.

A feature and advantage of certain embodiments of the invention provides a substrate container with deflector pieces at the purging outlet whereby purging gas that is circulated within the interior of the substrate container is redirected after the purging gas leaves the interior to wash the exterior surface of the substrate container.

A feature and advantage of certain embodiments of the invention provides a substrate container with purging outlets distributed over the container and with the outlets exiting to the exterior of the container the outlets redirecting the exiting purge gas in a direction parallel to the exterior surfaces of the container. Such purge outlets may have check valves therein to prevent flow of gases into the interior when the purging is not occurring.

A feature and advantage of certain embodiments of the invention is a substrate container with a plurality of purging inlets, at least one purge inlet directed into the interior of the substrate container and at least one purge inlet directed to washing the exterior surface of a wall defining the interior containment of the substrate container.

A feature and advantage of certain embodiments of the invention is a substrate container with a plurality of purging inlets, at least one purge inlet directed into the interior of the substrate container and at least one purge inlet directed to washing the exterior surface of a wall defining the interior containment of the substrate container.

A feature and advantage of certain embodiments of the invention provides for deflector pieces at the purging outlets whereby purging gas that is circulated within the interior of the substrate container is redirected after the purging gas leaves the interior to wash the exterior surface of the substrate container. Such deflectors can be attached or fixed to the substrate container or may be separate therefrom, such as part of the stocker or enclosure for the container.

A feature and advantage of certain embodiments of the invention is that the purge gas that is highly concentrated (such as very clean and very dry air) can optimally be utilized by dispersing it in close proximity to the outside surface of a substrate container thereby minimizing moisture permeation and maintaining minimal moisture in the polymer shell of the reticle pod and accelerating diffusion from the substrate container surface

### DESCRIPTION OF THE FIGURES

FIG. 1 is a diagrammatic view of a reticle pod stocker with purging features in accord with the invention herein.

FIG. 2 is a diagrammatic view of a wafer container, stocker with purging features in accord with the invention herein.

FIG. 3 is a perspective view of a reticle SMIF pod in accord with the invention herein.

FIG. 4 is a cross sectional diagrammatic view of the reticle pod of FIG. 3 connected to purging systems in accord with the inventions herein.

FIG. 5 is another diagrammatic view of a reticle SMIF pod in accord with the invention herein.

FIG. 6 is a diagrammatic view of a SMIF pod in accord with the invention herein.

FIG. 7 is a diagrammatic view of a SMIF pod in accord with the invention herein.

FIG. 8 is a detailed cross sectional view of a purge deflector with a check valve in accord with the invention here in.

FIG. 9 is cross sectional view of a SMIF pod in accord with the invention herein.

FIG. 10 is a perspective exploded view of a SMIF pod for semi-conductor wafers in accord with the invention herein.

FIG. 11 is a perspective view of a front opening wafer container in accord with the invention herein; for example a 300 millimeter front opening unified pod, a FOUP.

FIG. 11a is bottom view of the FOUP of FIG. 11.

FIG. 12 is an exploded view of a front opening substrate container in accord with the invention herein.

FIG. 13 is a cross sectional view of wall detail of a substrate container in accord with the invention herein.

FIG. 14 is an alternate view of the cross sectional detail of a substrate container in accord with invention herein.

### DETAILED DESCRIPTION OF THE PREFERRED EMBODIMENTS

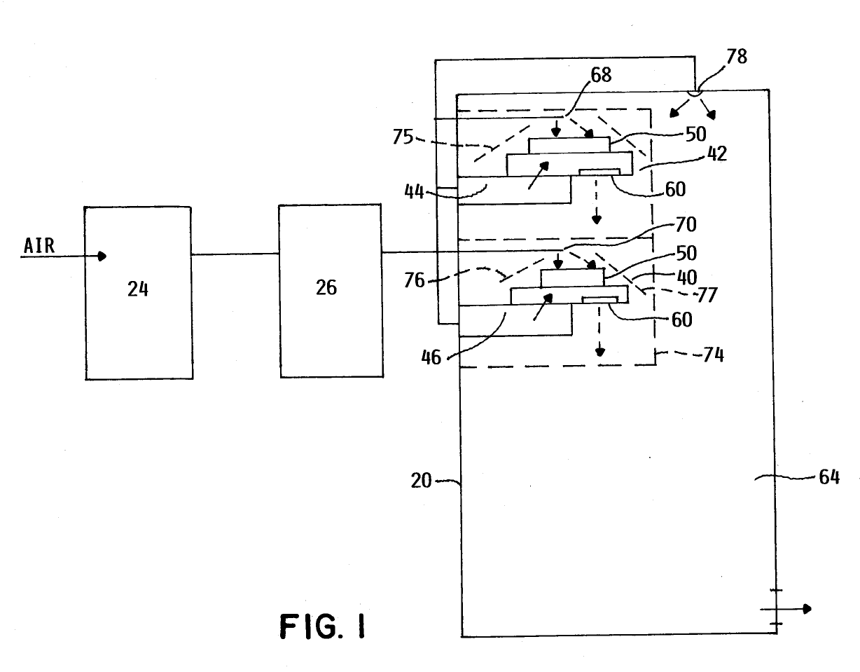

Referring to FIG. 1, an enclosure 20 is illustrated configured as a reticle SMIF pod stocker having purge gas supplies 24 and 26. Alternatively, the substrate container may be wafer containers such as those known as FOUPs (front opening unified pods) and FOSBs (front opening shipping boxes). In such stockers clean dry air or very clean dry air may be provided to the enclosure. Alternatively a pure inert gas such as nitrogen may be provided. The stocker has receiving regions 40 and 42 where reticle SMIF pods seat on shelves 44, 46 the reticle SMIF pods 50 have purge inlets at the bottom of said reticle pods whereby a purging gas is provided into he interior of said reticle pods. Said purging gas may be discharged through filters 60 in the base of the reticle pod into the ambient environment 64 of the stocker additional exterior surface purge gas is provided by purge outlets, such as nozzles 68, 70, which are directed towards the exterior of the reticle SMIF pod. Shrouds or directing plates 75, 76, 77 may be utilized downstream of the nozzles to direct the air or gas flow to the exterior surface of the pod This concentrated purge gas provides drawing of the polymer shell of the reticle pods and prevents permeation of moisture therein and drys out the polymer shell. The enclosure may have partitions 74 to isolate said reticle pods to allow maximum concentration of the purged gas provided for the exterior washing of said pods. An additional purge gas outlet 78 may be provided in the interior for providing generally clean air into the interior of the reticle pod stocker. See PCT/US2007/014428 incorporated herein by reference for explanation and descriptions of CDA and extra clean dry air.

Note that the various purge gases provided may be optimally composed and have varying levels of dryness and/or cleanliness for the specific intended function, that is, interior purging, exterior purge gas washing, or providing the ambient atmosphere in the stocker.

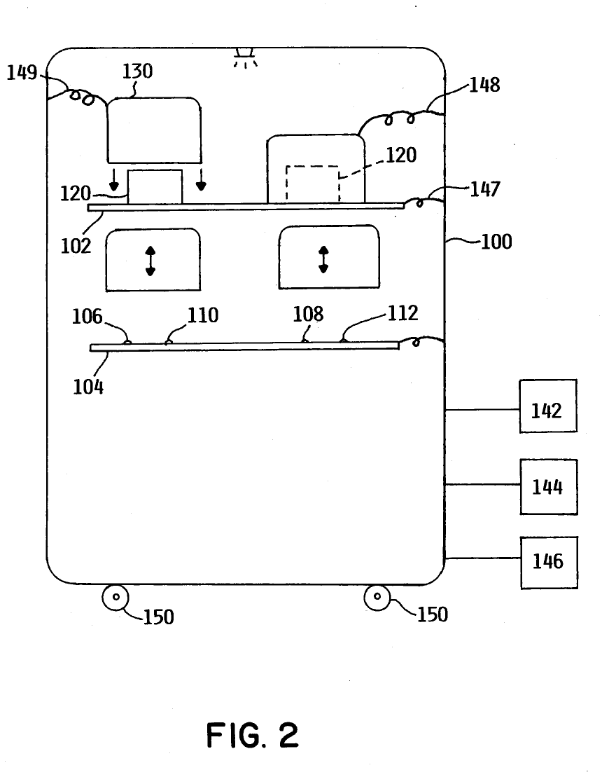

Referring to FIG. 2, a further enclosure 100 is illustrated having shelves 102, 104. Said shelves having purging outlets 106, 108 and purging exhaust receivers 110, 112 for receiving the purged gas after it has circulated through the wafer container. Wafer containers such as SMIF pods or FOUPs 120 may be placed on said shelves to seat on the respective purging outlets and purging exhaust fittings. Additionally, shrouds 130 are provided that are movable upwardly and downwardly to generally enclose the substrate containers providing a restrictive interior space whereby a specific purging gas may be provided to effectively the wash the exterior of the substrate container 120. Said purging gas may be exhausted between the juncture of the shroud and shelf or through other venting or outlet exhaust means. Various supplies of purging gas may be provided as illustrated by supplies 142, 144, 146 and purge gas lines 147, 148, 149. Such supplies may be different gasses such as nitrogen versus air and may be provided with varying degrees of cleanliness and/or dryness as desired or appropriate. The enclosure of FIG. 2 may be portable as illustrated by wheels 150 to transport the substrate containers within a fabrication facility typically intermediate processing steps.

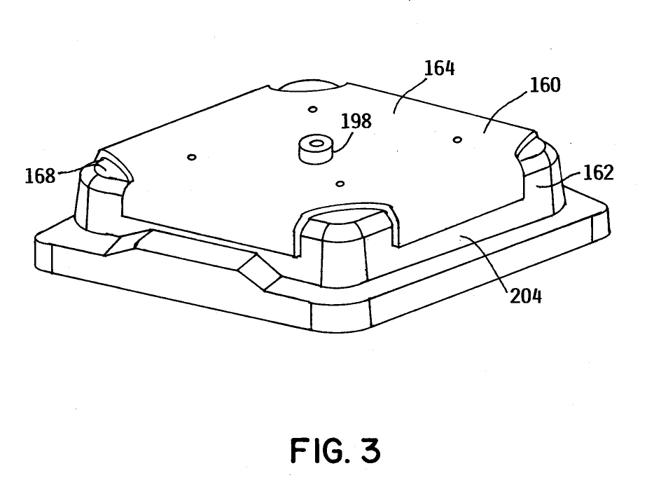

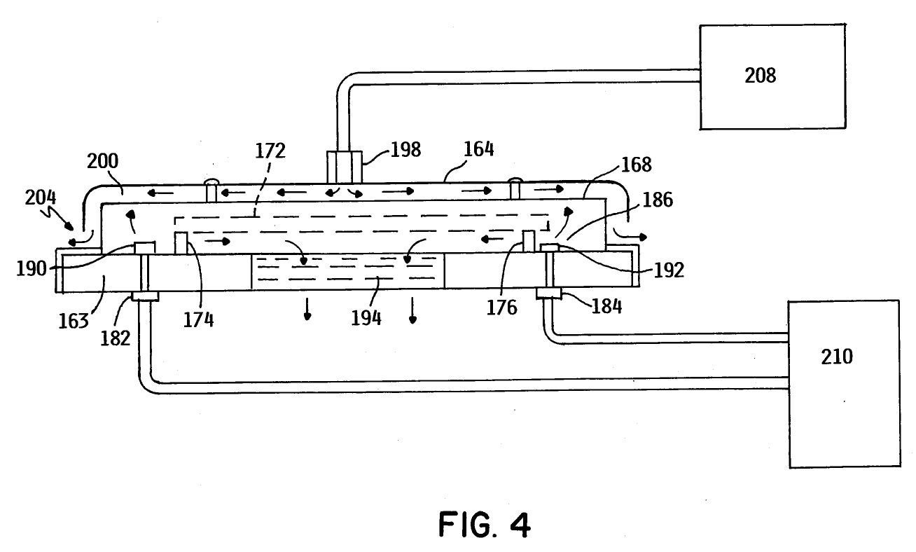

Referring to FIGS. 3 and 4, a SMIF pod is illustrated generally configured as a reticle SMIF pod 160. Said reticle SMIF pod is generally comprised of a shell portion 162, a door 163, and a shroud 164. The shroud 164 is configured to overlay in juxta position to the outside surface 168 of the shell portion. Said shell portion operates as a containment for the reticle contained therein. Referring specifically to FIG. 4 the reticle 172 is illustrated by dashed lines and is supported by reticle supports 174, 176. The door has a pair of purge inlets 182, 184 which are connected to the interior 186 of the reticle pod as defined by the shell and the door. Purge nozzles 190, 192 inject purge gas into the interior of said reticle SMIF pod. In this configuration the purge gas is exhausted through a filter 194 positioned centrally in the door 163. The shroud 164 has a further purge inlet 198 which leads into the space 200 defined between the shroud 164 and the exterior surface 168 of the shell. Said purge gas injected into said space 200 and is conveyed along and adjacent to said exterior surface, in a direction parallel to said exterior surface, and is directed to and follows the contours of said exterior surface as constrained by said shroud. The purge gas may be exhausted at the openings 204. T gas flow is illustrated generally by the arrows in the figures and particularly here in the space 200. Different purge gas sources 208, 210 can be provided for the purge gas providing varying compositions and/or cleanliness and/or dryness.

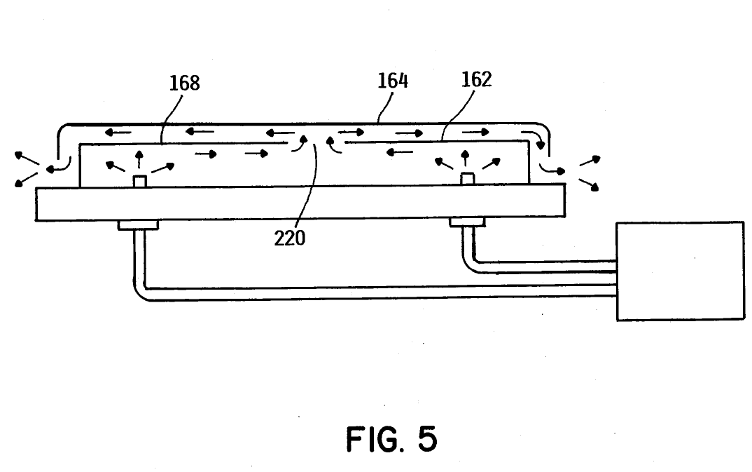

FIG. 5 illustrates an alternative view of a SMIF pod in which the purge gas is injected into the interior of the SMIF pod to be exhausted out an outlet 220 in the SMIF pod shell portion 162. Said purge gas is thus circulated in the interior of the SMIF pod and then exits and is forced to travel along the exterior surface 168 of the shell as directed by the shroud 164.

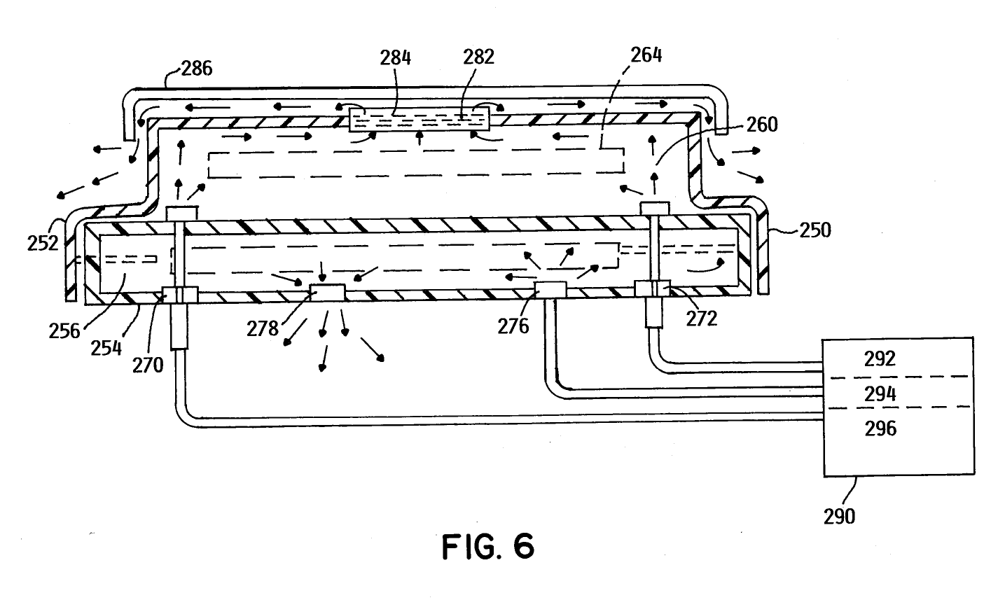

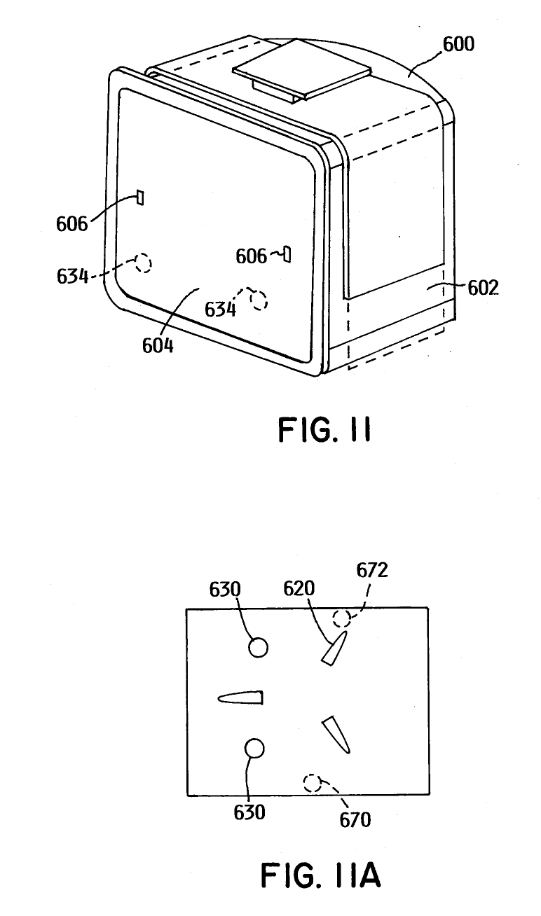

Referring to FIG. 6, a further embodiment of a SMIF pod 250 is illustrated. The SMIF pod has a shell portion 252, a door 254, with an interior 256. The door and the shell portion define an interior 260 for the containment of the reticle 264. The door has, in this embodiment, two purge inlets 270, 272 that lead into the interior of the reticle pod where the reticle is contained. A third purged inlet 276 leads into the interior of the door. The door has a purge outlet 278 whereby purge gas injected into the door interior 256 is exhausted out of the door. In SMIF pods, the doors are positioned at the bottom of the pods; in FOUPS and FOSBs, the doors are positioned at an open front of the container portion, see FIG. 11. Such FOUP and FOSB doors will often have open interiors that may similarly be purged. In the configuration of FIG. 6, the purge gas injected into the interior of the reticle pod, where the reticle is stored, is exhausted out an opening 282 in the shell. Said opening having a filter 284 disposed therein as disclosed in US 2006/0266011, incorporated herein by reference. The exhaust gas for the interior of the reticle pod is then forced along the exterior surface of the shell portion by the shroud 286. The purge gas supply 290 may have separate portions 292, 294 for providing purge gas of different compositions and/or cleanliness and/or dryness.

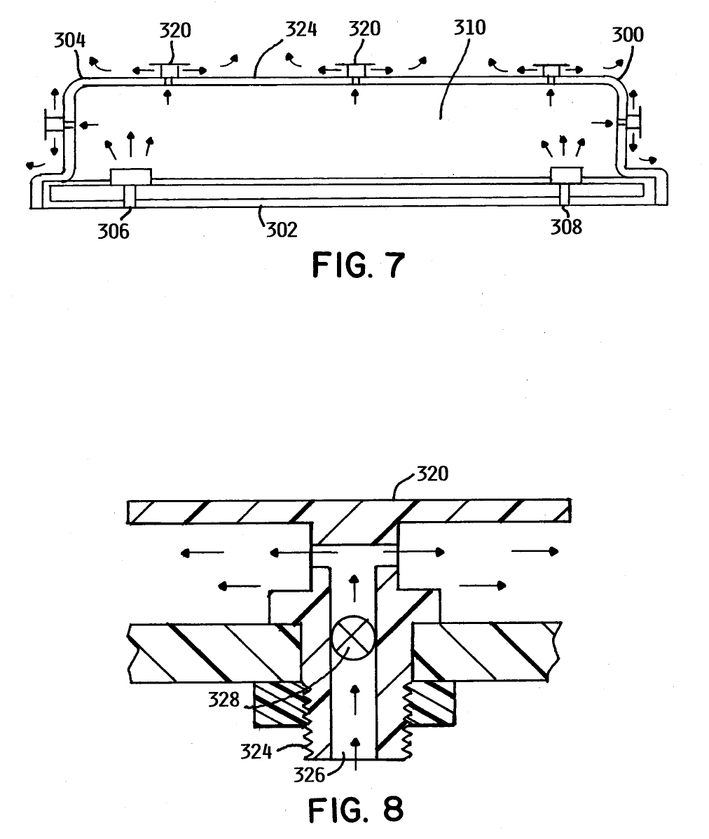

Referring to FIG. 7, a further SMIF pod 300 is illustrated. The SMIF pod generally comprises a door 302 and a shell portion 304. The door has purge inlets 306, 308 that are connectable to purge sources and that inject the purge gas into he interior 310 of the SMIF pod 300. In this configuration the shell has a plurality of outlets to exhaust the purge gas and a plurality of deflectors 320 positioned at each of the shell outlets. The deflectors deflect and direct the exhaust gas leaving the interior of the SMIF pod to wash the exterior surface 324 of the shell. Such an arrangement is also suitable for other substrate containers, such as wafer containers, see below.

Referring to FIG. 8 a cross sectional detail is illustrated of a configuration of the deflector, said deflector 320 is T-shaped with a threaded end 324 having a conduit pathway 326 extending through and exiting in a lateral direction a check valve 328 is appropriately putted in the outlet to provide for one-way outlet flow only. This may be on the SMIF pods or wafer containers described herein.

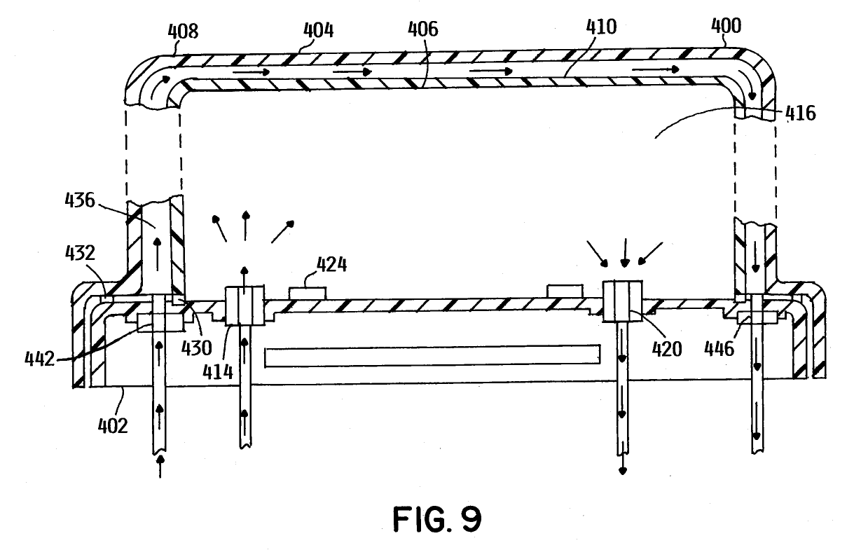

Referring to FIG. 9, a further embodiment of a SMIF pod 400 is illustrated and is comprised generally of a door 402 and a shell portion 404. The shell portion comprises an inner wall 406 and an outer wall 408. The inner wall has an outwardly facing surface 410. The SMIF pod has, in this configuration, four purge ports and inlet port 414 configured to inject purged gas into the interior 416 of the reticle pod to be exhausted out the exhaust port 420. Said ports are suitably located in the door. Substrate support structure 424 is provided on the door and can be configured either as a support for reticles or to position a conventional h-bar wafer carrier. The shell portion seals with the door by way of seals 430 and 432. The secondary seal 432 provides containment of the space 436 intermediate the inner shell wall and the outer shell wall. An additional purge port 442 is provided to inject a purge gas in the space between the inner shell portion and the outer shell portion. An additional exhaust port 446 is provided to provide an exit of the purged gas exhausted from the space intermediate the wall portions. Although this door is not shown in FIG. 9 to have an interior as illustrated in FIG. 6 and FIG. 7 it is understood by those knowledgeable in the art that said doors would be feasible in the FIG. 9 configuration and should be included and considered as a embodiment of the invention herein.

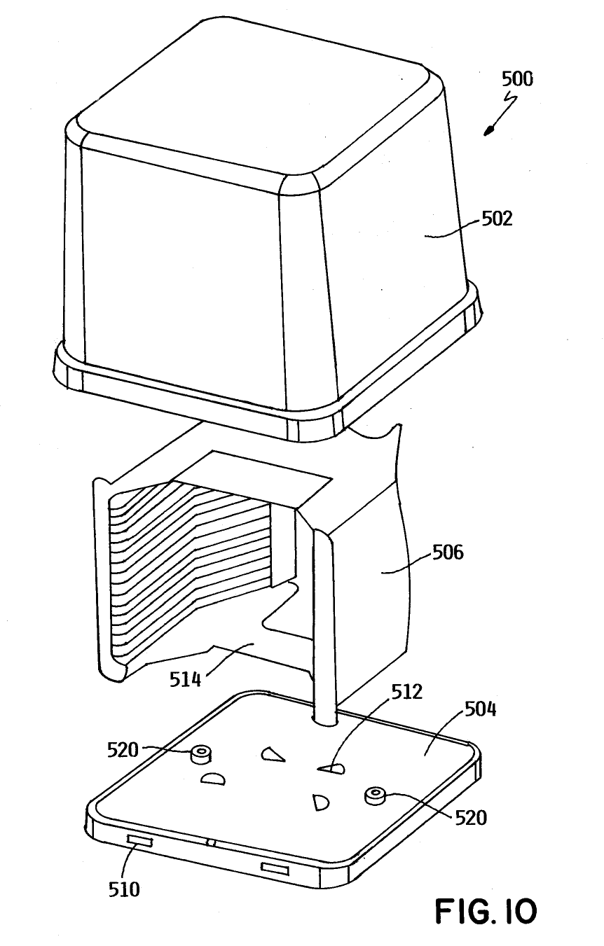

Referring to FIG. 10, a conventional SMIF pod 500 is a illustrated with a shell portion 502, a door 504, and an H-bar wafer carrier 506. The door has an internal latch mechanism 510 that will engage with the inside purify of the shell portion 502 to secure the door in place as is conventional with SMIF pods. The door also has support structure 512 to properly position the h-bar 514 of the carrier thereon. Additional purge ports 520 are positioned in the bottom of the door to be engaged from below the door. This SMIF pod may have the upper shell portion configured as illustrated in FIG. 9 and may have the door as illustrated in either FIG. 9 or the figures illustrating doors with the open interiors, see FIGS. 6 and 7.

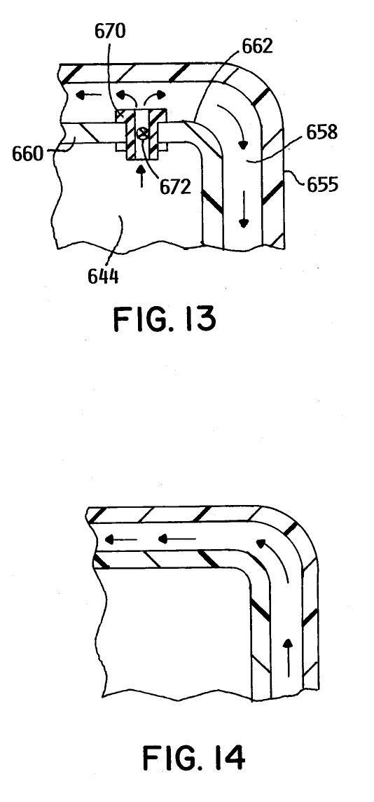

Referring to FIG. 11, a front opening pod 600 is illustrated. Such pods are often known as front opening unified pods (FOUPs) and are utilized for storing 300 millimeter wafers intermediate process steps. The container comprises generally a container portion 602, a door 604 with latch mechanisms, and latch mechanisms key holes 606 in the front of the door. Said door sealingly engages to the shell portion 602 to create a hermetic interior. A bottom side is illustrated in FIG. 11 a and has an industry standard three-groove kinematic coupling 624 positioned thereon. Purge ports 630 may be positioned on the bottom base of the shell portion or are alternatively positioned on the front door as illustrated by the dash lines on FIG. 11 with the numeral 634. The shell portion of the container of FIG. 11 may have a double wall configuration as illustrated in FIGS. 13 and 14. Wafers are contained within the interior 644 of the wafer container and would be conventionally purgeable. An additional supplemental wall 650 may be provided to provide a space 658 between the inner wall 660 and the outer wall 655. The inner wall has an exteriorly facing surface 662 which is exposed to the interior purged gasses, as indicated by the arrows, and may circulate within the interior between the double wall sections to provide a drying effect to the polymer interior wall and prevent permeation of moisture inwardly. The purge gas can be exhausted from the interior through a port 670 with a check valve 672 as illustrated in FIG. 13 or can be discharged by way of a separate purge port position in the base of the container portion, see FIG. 14. Said port could be as indicated on FIG. 11, as illustrated by the dashed lines enumerated with 670, 672. Rather than have the space 658 within the double wall of the FOUP defining a secondary sealed enclosure, such as is illustrated in the SMIF pod of FIG. 9, said double wall may be configured as a shroud as illustrated in FIG. 11. In either case a purge gas is provided and directed along the exterior facing surface of the wall portions that define the confined interior where the wafers are contained.

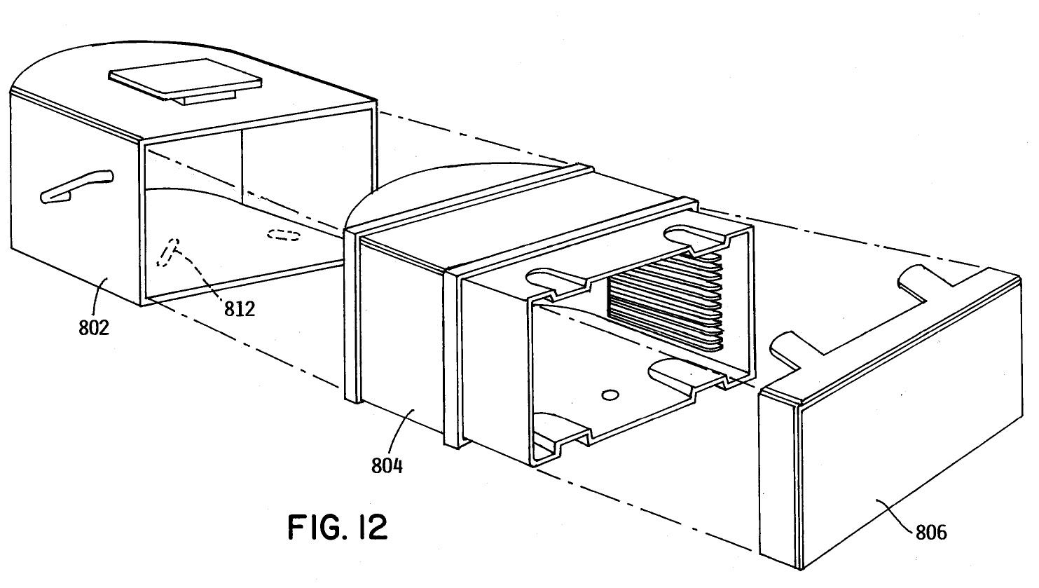

Referring to FIG. 12, a configuration is illustrated that would be appropriate for providing the double wall section with sealed interior spaces. This configuration has an exterior shell portion 802, an interior shell portion 804, and a door 806. When assembled a gap is provided between the outer shell and the inner shell with said space between said shells being purgeable to accomplish the functions as described above. Similarly the interior of said container also would suitably would purgeable. Front opening containers as such are typically have machine interfaces configured as threes groove kinematic coupling 812.

We claim:

1. An enclosure for holding wafer containers with wafers therein, the enclosure having an opening for receiving wafer containers and having two purging systems each providing a purge gas of a different concentration or composition, one for the interior of the wafer containers and one for directing a purge gas to the exterior surface of a confining wall of the wafer container.

2. The enclosure of claim 1 wherein the enclosure is movable for transporting wafers within the confines of a fabrication facility.

3. An enclosure for holding wafer containers with wafers therein, the enclosure accessible for receiving wafer containers and having a shroud that is removable for placement and removal of the shroud and that extends at least partially over a wafer container for providing a purge gas intermediate said shroud and the wafer container for washing the exterior surface of containment walls of the wafer container with a purge gas.

4. An enclosure for holding a plurality of wafer containers with wafers therein, the enclosure having individual receiving regions for individual wafer containers, each receiving region having one purge outlet for interior purging of the wafer container and one outlet for purging the exterior of the container.

5. The enclosure of claim 4 wherein the purge outlet for interior purging is connected to a nitrogen gas source and the outlet for purging the exterior of the container is connected to a source of clean dry air.

6. An enclosure for holding a plurality of wafer containers with wafers therein, the enclosure having individual receiving regions for individual wafer containers, each receiving region having one purge outlet for interior purging of the wafer container and one outlet for purging the exterior of the container, the enclosure further having an ambient air cleaning system.

7. A method for reducing crystal forming contaminants with a controlled environment in a substrate container, the method comprising the steps of:
enclosing a substrate that is vulnerable to crystal formation in a sealed, openable substrate container;
purging the interior of the container with nitrogen;
providing a exterior surface purge gas wash of the container with at least clean dry air; and
constraining the exterior wash within a few inches of the exterior surface.

8. The method of claim 7 wherein the step of purging the interior of the container includes injecting nitrogen into the interior.

9. The method of claim 7 wherein the step of claim 7 includes utilizing clean dry air for the exterior surface purge gas wash.

10. The method of claim 7 including the step of enclosing the substrate container in a stocker with purge connections for accomplishing the interior purge and the exterior surface purge gas wash.

11. A system for providing double purging for a wafer container including an internal purge and an external wafer container surface purge wherein the external surface purge.

12. A system for providing an external purge washing of the containment walls of a wafer container, the system comprising purge outlets proximate to the wafer container.

13. A wafer container having a shroud for concentrating an external purge along the exterior surface of a containment wall.

14. A wafer container having a purge outlet that deflects purge gas along the exterior surface of the wafer container.

15. A wafer container having a pair of purge inlet portions, one for purging the interior of the wafer container and one for purging the exterior surface of walls defining the interior.

16. A wafer container having purge conduits for directing purge gas to the exterior surface of containment walls of the container.

17. A wafer container having purge conduits extending over the exterior surface of containment walls for conveying and constraining purge gas for washing the exterior surface of the containment walls of the wafer container.

18. A wafer container having a door and a shell portion sealable together to define an interior for holding wafers, the shell portion having a double wall and a port for injecting purge gas therein.

19. The wafer container of claim 18 wherein the door has an open interior and a latching mechanism therein and a port for injecting purge gas into said interior of said door.

20. A shroud conforming to a portion of the exterior shape of a wafer container for defining a space along the exterior surface of the wafer container whereby a purge gas may be injected into said space can washing the exterior surface of containment walls of the wafer container.

21. A method of minimizing haze growth and contamination of wafers in a sealed wafer container, the method comprising the steps of:
providing an interior purge of the wafer container;
providing an exterior purge directed to the exterior walls of the wafer container by way of a dedicated purge outlet.

22. A method of minimizing haze growth and contamination of wafers in a sealed wafer container, the method comprising the steps of:
providing an interior purge of the wafer container;
providing an exterior purge directed to the exterior walls of the wafer container by way of a dedicated purge outlet.

23. A front opening wafer container for 300 mm wafers, having a containment wall with means for purge gas washing of an exterior surface of the containment wall.

24. The container of claim 23 wherein the means is a double wall providing a secondary sealed interior or a shroud.

25. An enclosure for holding substrate containers, the substrate containers each configured for holding at least one substrate therein, the enclosure having a closable opening for receiving the substrate containers, the enclosure having two purging systems each providing a purge gas of a different concentration or composition, one for the interior of the substrate containers and one for directing a purge gas to the exterior of the wafer container.

26. The enclosure of claim 25 wherein the enclosure is movable for transporting wafers within the confines of a fabrication facility.

27. An enclosure for holding wafer containers with wafers therein, the enclosure accessible for receiving wafer containers and having a shroud that extends at least partially over a wafer container for providing a purge gas intermediate said shroud and the wafer container for washing the exterior surface of containment walls of the wafer container with a purge gas.

28. An enclosure for holding a plurality of substrate containers with substrates therein, the enclosure having individual receiving regions for individual substrate containers, each receiving region having one purge outlet for interior purging of the wafer container and one outlet for purging the exterior of the container.

29. The enclosure of claim 28 wherein the purge outlet for interior purging is connected to a nitrogen gas source and the outlet for purging the exterior of the container is connected to a source of clean dry air.

30. The enclosure of claim 28 wherein each substrate container has a pair of purge inlets, one inlet for receiving purge gas for the interior of said substrate container, the other for receiving purge gas to wash the exterior surface of a containment wall of the substrate container.

31. An enclosure for holding a plurality of substrate containers with substrates therein, the enclosure having individual receiving regions defined by partitions for individual substrate containers, each receiving region having one purge outlet for interior purging of the substrate container and one outlet for purging the exterior of the container, the enclosure further having an ambient air cleaning system.

32. An enclosure for holding a plurality of substrate containers with substrates therein, the enclosure having individual receiving regions for individual substrate containers, each receiving region having a shroud for at least partially covering the respective substrate container seated at said receiving region., each receiving region having one purge outlet for interior purging of the wafer container and one outlet for purging the exterior of the container,

33. An enclosure for holding a plurality of substrate containers with substrates therein, the enclosure having individual receiving regions for individual substrate containers, each receiving region having a shroud for at least partially covering the respective substrate container seated at said receiving region., each receiving region having one purge outlet for interior purging of the wafer container and one outlet for purging the exterior of the container,

34. A system for providing double purging for a reticle SMIF pod including an internal purge and an external wafer container surface purge wherein the external surface purge is constrained to follow the contours of the external surface of the reticle SMIF pod.

35. A system for providing an external purge washing of the containment walls of a reticle SMIF pod, the system comprising purge outlets proximate to the wafer container.

36. A reticle SMIF pod having a shroud for concentrating an external purge along the exterior surface of a containment wall of the reticle SMIF pod.

37. A reticle SMIF pod having a purge outlet that deflects purge gas along the exterior surface of the reticle SMIF pod.

38. A reticle SMIF pod having a pair of purge inlet portions, one for purging the interior of the reticle SMIF pod and one for purging the exterior surface of walls defining the interior.

39. A reticle SMIF pod having purge conduits for directing purge gas to the exterior surface of containment walls of the container.

40. A reticle SMIF pod having purge conduits extending over the exterior surface of containment walls for conveying and constraining purge gas for washing the exterior surface of the containment walls of the reticle SMIF pod.

41. A reticle SMIF pod having a door and a shell portion sealable together to define an interior for holding reticles, the shell portion having a double wall and a port for injecting purge gas therein.

42. The reticle SMIF pod of claim 41 wherein the door has an open interior and a latching mechanism therein and a port for injecting purge gas into said interior of said door.

43. A shroud conforming to a portion of the exterior shape of a reticle SMIF pod for defining a space along the exterior surface of the reticle SMIF pod whereby a purge gas may be injected into said space can washing the exterior surface of containment walls of the reticle SMIF pod.

44. A method of minimizing haze growth and contamination of reticles in a sealed reticle SMIF pod, the method comprising the steps of:
providing an interior purge of the reticle SMIF pod;
providing an exterior purge directed to the exterior walls of the reticle SMIF pod by way of a dedicated purge outlet.

45. A method of minimizing haze growth and contamination of reticles in a sealed reticle SMIF pod, the method comprising the steps of:
providing an interior purge of the reticle SMIF pod;
providing an exterior purge directed to the exterior walls of the reticle SMIF pod by way of a dedicated purge outlet.

46. A system for providing double purging for a substrate container including an internal purge and an external wafer container surface purge wherein the external surface purge is constrained to follow the contours of the external surface of the substrate container.

47. A system for providing an external purge washing of the containment walls of a substrate container, the system comprising purge outlets proximate to the wafer container.

48. A substrate container having a shroud for concentrating an external purge along the exterior surface of a containment wall of the substrate container.

49. A substrate container having a purge outlet that deflects purge gas along the exterior surface of the substrate container.

50. A substrate container having a pair of purge inlet portions, one for purging the interior of the substrate container and one for purging the exterior surface of walls defining the interior.

51. A substrate container having purge conduits for directing purge gas to the exterior surface of containment walls of the container.

52. A substrate container having purge conduits extending over the exterior surface of containment walls for conveying and constraining purge gas for washing the exterior surface of the containment walls of the substrate container.

53. A substrate container having a door and a shell portion sealable together to define an interior for holding reticles, the shell portion having a double wall and a port for injecting purge gas therein.

54. The substrate container of claim 41 wherein the door has an open interior and a latching mechanism therein and a port for injecting purge gas into said interior of said door.

55. A shroud conforming to a portion of the exterior shape of a substrate container for defining a space along the exterior surface of the substrate container whereby a purge gas may be injected into said space can washing the exterior surface of containment walls of the substrate container.

56. A method of minimizing haze growth and contamination of wafers in a sealed substrate container, the method comprising the steps of:
providing an interior purge of the substrate container;
providing an exterior purge directed to the exterior walls of the substrate container by way of a dedicated purge outlet.

57. A method of minimizing haze growth and contamination of substrates in a sealed substrate container, the method comprising the steps of:
providing an interior purge of the substrate container;
providing an exterior purge directed to the exterior walls of the substrate container by way of a dedicated purge outlet.
